(19) United States
(12) Patent Application Publication
(10) Pub. No.: US 2015/0134401 A1
(43) Pub. Date: May 14, 2015

(54) IN-MEMORY END-TO-END PROCESS OF PREDICTIVE ANALYTICS

(71) Applicants: CARSTEN HEUER, SCHIESHEIM (DE); NIELS SCHMITT, HEIDELBERG (DE)

(72) Inventors: CARSTEN HEUER, SCHIESHEIM (DE); NIELS SCHMITT, HEIDELBERG (DE)

(21) Appl. No.: 14/076,187

(22) Filed: Nov. 9, 2013

(51) Int. Cl. G06Q 30/02

(52) U.S. Cl. CPC G06Q 30/0202
USPC 705/7.29

(57) ABSTRACT

An in-memory end-to-end method for predictive analytics is implemented. A predictive business process to consume a predictive functionality is initiated. At runtime of the predictive business process, a trained predictive model is retrieved from an in-memory database. In one aspect, the trained predictive model is based on a predictive scenario implementing the predictive functionality. In one aspect, the predictive scenario is stored in the in-memory database. A key predictive indicator is calculated by executing the trained predictive model. Calculating is performed in the in-memory database.

### BACKGROUND

Predictive analytics encompasses a variety of statistical techniques and data mining methods that enable building predictive models and visually interact with the data to discover hidden insights and relationships in the data, and thereby provide the basis for making predictions about future events. Examples of such statistical methods are descriptive models which classify customers or prospects into groups, decision models which predict the results of decisions involving various variables, and predictive models which analyze historical data to assess how likely a specific behavior is to occur. These models are used for forecasting and discovering of key influencers, trends, relationships, anomalies, etc.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a flow diagram illustrating an end-to-end business process for predictive analytics, according to one embodiment.

FIG. 2 is a flow diagram illustrating process to consume an implemented predictive functionality by an end user, according to one embodiment.

FIG. 3 is a flow diagram illustrating process to determine an optimized target group for a marketing campaign by calculating buying propensity, according to one embodiment.

FIGS. 4-8 are block diagrams illustrating consumption of buying propensity functionality by an end user via one or more GUIs of a predictive functionality consumer application, according to one embodiment.

FIG. 9 is a flow diagram illustrating process to calculate a model fit, according to one embodiment.

FIG. 10 is a block diagram illustrating a GUI that includes a number of created predictive models, according to one embodiment.

FIG. 11 is a block diagram illustrating a GUI showing details of a predictive model, according to one embodiment.

FIG. 12 is a block diagram illustrating a GUI showing details of a model fit, according to one embodiment.

FIG. 13 is a block diagram illustrating a GUI showing details of a model fit, according to one embodiment.

FIG. 14 is a block diagram illustrating a representation of a predictive model, according to one embodiment

FIG. 15 is a flow diagram illustrating process for implementing a predictive scenario, according to one embodiment.

FIG. 16 is a block diagram illustrating an exemplary in-memory database table model 1600 of a predictive scenario, according to one embodiment.

FIG. 17 illustrates exemplary computer system 1700 of an application providing predictive functionality, according to one embodiment.

FIG. 18 is a block diagram illustrating an exemplary computer system.

### DETAILED DESCRIPTION

Embodiments of techniques for in-memory end-to-end process of predictive analytics are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Today, predictive calculations are done externally in different systems and environments. Normally, data from disparate systems are collected into separate data marts external to the systems, statistical tools are run or executed over those data marts, and finally predictive results are communicated back to the business people by the statisticians. One impediment in leveraging predictive analytics for business users today is the transfer of a predictive model result calculated by a statistician to the business people. Further, business people may have vague business requirements, which are addressed to a statistician, either in-house or to external consultant. Usually, a statistician (e.g., advanced analyst) is not part of a business team. Often, communication between business people and statisticians is not clear. Difficulties are the translation of business requirement towards data analysis by the statistician and later communication of statistician's results back to business people. Often there are misunderstandings and several iterations required to reach the expected outcome, if at all. Therefore, integration of predictive results into business decisions is cumbersome, may not be well accepted and it may fail. In some instances business people and statisticians do not interact well and the potential of findings from statistical calculations to come to optimal business decisions may not be leveraged.

In one embodiment, an end-to-end real-time business process of predictive analytics is implemented. By establishing an integrated end-to-end business process of predictive analytics, a predictive functionality is consumable by end users who have no statistical expertise. Further, the predictive functionality is consumable in runtime of the business process of predictive analytics. In one embodiment, processing of the end-to-end business process for consuming predictive analytics takes place in-memory, i.e., in the main memory. Predictive functionality is calculated in and consumed based on an in-memory database.

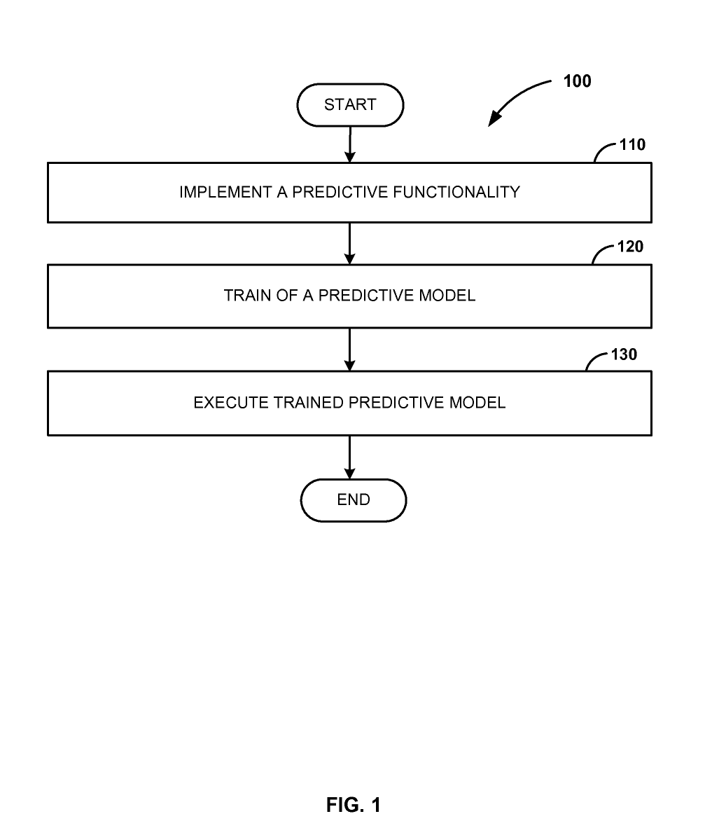

FIG. 1 illustrates end-to-end business process 100 of predictive analytics, according to one embodiment. At 110, a predictive functionality is implemented. The predictive functionality may be implemented by a user with an advanced analyst role. The advanced analyst may understand the business question in focus. The advanced analyst may create the data foundation needed to answer the business problem with predictive functionality and may choose the appropriate statistical method. For example, the advanced analyst may set up the data foundation for the predictive functionality. The advanced analyst may be a statistician with skills including, but not limited to, statistical libraries such as SAP® HANA Predictive Analytics Library (PAL), R, IBM® SPSS, etc. The advanced analyst performs data collection, integration and preparation. For example, the advanced data may investigate data to discover distribution, correlation, missing values, outliers, etc. The advanced analyst also may enrich the data by defining, e.g., categorization of continuous variables, data transformation, etc. In one embodiment, the advanced analyst creates an in-memory data model of source data of the predictive functionality, e.g., in-memory predictive data model.

Source data is consolidated from a number of sources into one in-memory database. In one embodiment, data is replicated real time from systems such as an Enterprise Resource Planning (ERP) system, a Customer Relationship Management (CRM) system, and other systems. In one embodiment, a predictive functionality may be implemented initially once and, then, revised or monitored occasionally.

In one embodiment, a predictive functionality may be implemented in different ways, for example, using different statistical methods. In one embodiment, one or more predictive scenarios may implement a predictive functionality. The predictive scenarios may be consumed in runtime of a predictive business process. A predictive scenario is a combination of a business use case, data source and assigned one or more statistical methods. For example, a predictive scenario may represent a process for calculation of buying propensity (or product affinity), where the statistical method used may be logistic regression, and the data source may be customized in-memory data model dedicated for consumption of regression method and designed for buying propensity use case. In one embodiment, the advanced analyst may select the proper statistical method and the data source to build the predictive scenario. The advanced analyst defines the predictive scenario, i.e., the implementation of the predictive functionality, for a specific business use case.

At 120, a predictive model is trained. In one embodiment, the predictive model may be trained by a user with a business analyst role. A predictive model is the specification of a predictive scenario including a target object and a target variable. A target object is an object for which a prediction is to be calculated, e.g., a specific product. A target variable is a variable related to the target object, which is included in the statistical calculation, for example, a binary variable to be included in a logistic regression. In one embodiment, a business analyst role is a separate role to manage and process predictive models. A user with business analyst role may perform actions including, but not limited to, creating and maintaining predictive models, executing or running different model fitting, assessing quality of a model fit, identifying the best fitting model, and publishing the best model to the business run time for consumption by the business user, etc. In one embodiment, the work of the business analyst is based on the pre-prepared predictive scenario supplied by the advanced analyst (e.g., supplied by step 110).

A predictive model is trained based on a training set. A training set is a sample data, for example, a set of customer accounts where the buying behavior is known from historical data. In one embodiment, the training set may be selected by the business analyst. Also, the business analyst may determine the target variable and may include available attributes in the predictive model as independent (explaining) variables. In one embodiment, the business analyst may analyze various combinations of explaining variables to identify the best fitting predictive model. A trained predictive model is also called a model fit. A model fit or a trained predictive model is an instance of a predictive model that has been trained on the specified training set, using the selected statistical method, where each predictive model is trained with different one or more predictors. In one embodiment, the business analyst may identify a best fitting trained predictive model. The business analyst may also publish for usage in runtime of the business process the best fitting predictive model. The training of predictive models may reoccur, for example, every month, week, or day, depending on the amount of new transactional data.

In one embodiment, the Business Analyst provides a trained predictive model for a predictive functionality with respect to certain business context. For instance, a decision tree predicting the buying probability of product ‘X’ for customers in the European market may be provided. To maximize predictive quality, control parameters of the statistical algorithms and variables from the predictive model may be adjusted. For example, the maximum depth or width of the decision tree can be restricted, in order to balance over- and under-fitting. The predictive quality of this adjustment is assessed by validating the model, which typically means to train the model on a random subset of the training set and to execute the trained model on the complementary set and measure the error rate. The trained model obtained from the adjustment with the best quality is deployed for use by the end users.

At 130, a trained predictive model is executed. In one embodiment, the best fitting predictive model is executed. Upon publishing or deploying the best fitting predictive model, the best fitting model is made available or provided in the run time of an end user. The end user is a business user such as Marketing Expert, Marketing Representative, Campaign Expert, Sales Representative, and the like. The business user is a business expert, who processes business steps and consumes predictive functionality, which is integrated in the UI to be directly consumed. In one embodiment, the best fitting predictive model is embedded in runtime of the business predictive process and integrated in the UI of the end user. Therefore, by analyzing predictive outcome in the UI, the business user may include the outcome of predictive models in his business processes and receive additional decision support. Once a predictive functionality is implemented it may be used in parallel by a number of users in the runtime of their respective predictive business processes.

In one embodiment, trained predictive models are integrated into the business run time of a predictive application and a primary business data source is directly accessed in an in-memory database. Thus, the need to extract data from transactional systems or data warehouses to a separate data mart for statistical analysis is not required with the integrated end-to-end business predictive process. The predictive functionality directly accesses the primary data on an in-memory database, hence, no data extraction into a data mart for further analysis required. Further, the need to transfer or communicate back the results from predictive models, generated in an external environment, to the business processes is overcome by calculating predictive results during run time of the business process. With an easy to consume UI the business user can directly use the predictive results, in real time, for business decisions. In one embodiment, predictive functionality is consumed by the end user at runtime of a business predictive process.

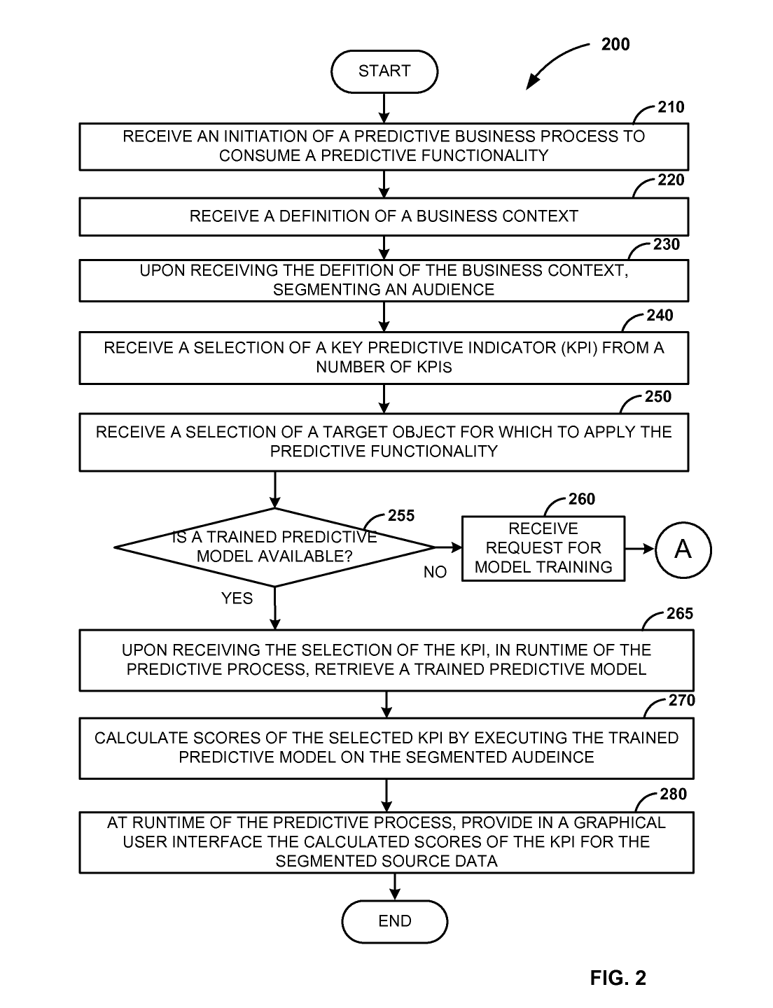

FIG. 2 illustrates a process 200 for consuming an implemented predictive functionality by an end user, according to one embodiment. A predictive functionality that is implemented may be provided in run time of a process for consuming the predictive functionality, according to one embodiment.

At 210, an initiation of a predictive business process to consume a predictive functionality is received. The predictive business process may be initiated by an end user. For example, a marketing campaign may be initiated by a Marketing Expert. At 220, a definition of a business context for the predictive functionally is received. For example, the Marketing Expert may define a market for marketing campaign by specifying criteria including, but not limited to, a country, region, industry, distribution channel or demographic criteria such as age, level of education, income, ethnicity and gender, etc. Another exemplary business context definition in the case of pattern detection in customer behavior may include specification of, for example, which customer attribute values are strong predictors for chum probability. In case of clustering, an exemplary business context definition may include for which attributes, contacts segments are homogeneous within, but different to other contacts segments.

In one embodiment, at 230, upon receiving the definition of the business context, an audience is segmented. An audience may be a segment created in Audience Discovery and Targeting (ADT) tool such as SAP® ADT. In one embodiment, the audience may depend on the predictive functionality to be consumed. For example, contacts are filtered from a root segment according to the specified criteria in the definition of the business context. In one embodiment, a segmentation object is created according to the definition of the business context, wherein the segmentation object is linked to the predictive functionality in the runtime of the predictive business process. In one embodiment, segmentation of audience may not be relevant for different predictive functionalities.

At 240, a selection of a key predictive indicator (KPI) for the predictive functionality is received. The KPI is selected from a number of available key predictive indicators (KPIs) that represent various implemented predictive functionalities, according to one embodiment. Examples of KPIs include, but are not limited to, customer lifetime value, buying propensity, chum probability, response probability, lead scoring, activity scoring, web-affinity scoring, channel-affinity scoring (i.e., what is the preferred sales channel, e.g., mail, letter, phone, etc., for different customer profiles), market basket analysis, product recommendation, etc.

In one embodiment, upon selecting the KPI, available predictive models trained for one or more target objects are provided in runtime of the predictive business process to the end user. The trained predictive models with respective target objects may be provided in an UI for the end user to consume. At 250, a selection of a target object for which to apply the predictive functionality is received. For example, upon selecting the KPI, the end user may select the target object. For example, a product for which to run a marketing campaign. At 255, a check is performed to determine if a trained predictive model is available. Whether a trained predictive model is available may be determined according to the audience segmentation and the selected KPI. In one embodiment, the trained predictive model may be calculated at run time of the business predictive process. In another embodiment, for performance reasons, trained models are executed in batch mode and the calculated scores are stored in the in-memory database. The stored scores may be selected from the database.

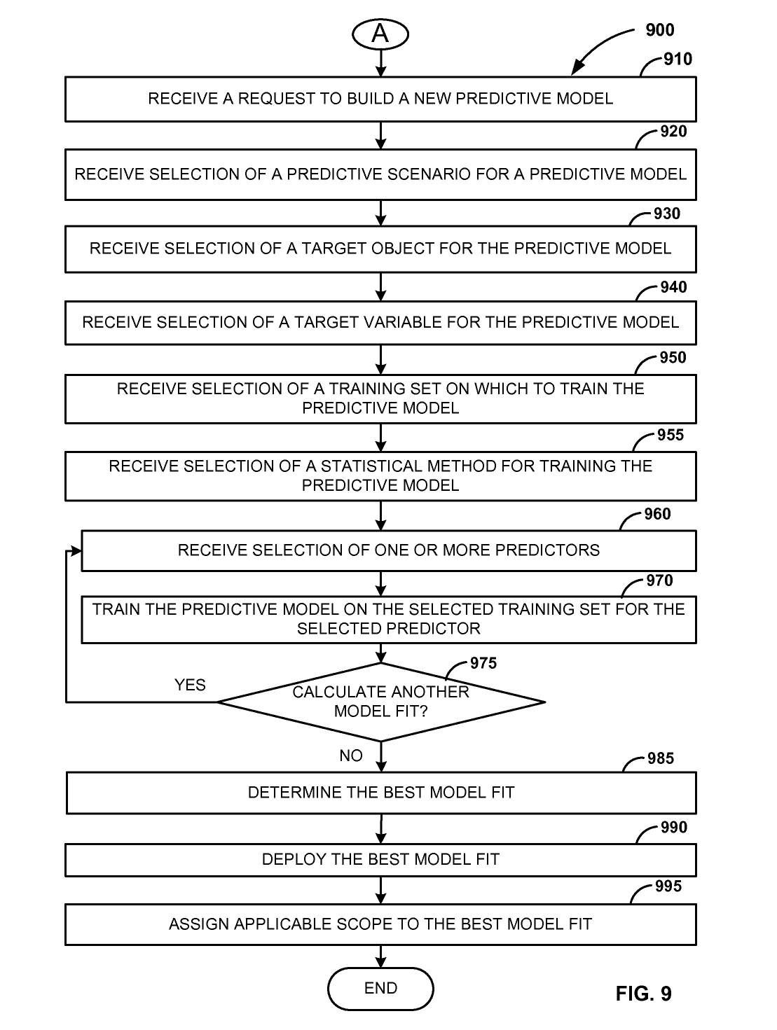

When a trained predictive model is not available, at 260, a request for model training is received. For example, a Marketing Expert may request a Business Analyst to train a predictive model for the selected business context, the KPI, and the target object. Process for model training is illustrated in FIG. 9. If a trained predictive model is available, at 265, upon receiving a selection of the KPI, in runtime of the initiated predictive business process, a trained predictive model is retrieved. In one embodiment, the trained predictive model is determined automatically at runtime of the predictive business process. In one embodiment, the provided trained predictive model may be a best fitting predictive model (also called best model fit). The best fitting model may be determined and chosen manually by the business analyst after assessment of different model fits.

At 270, scores for the selected KPI are calculated by executing the trained predictive model on the segmented audience. The predictive outcome is calculated. In one embodiment, for each member of target group, a value of the selected KPI is calculated by executing the trained predictive model on the target group. The target group may be the segmented audience, according to one embodiment. For example, for each customer of a predefined market, a buying propensity score for a selected target object ‘product X’ may be calculated.

In one embodiment, at 280, the calculated scores of the selected KPI may be provided in a graphical user interface at the runtime of the predictive process. The end user may consume the predictive outcome in the UI, at runtime of the predictive business process. For example, a Lorenz curve or a decision tree may be generated upon calculation of the KPI. Thus, predictive functionality is integrated directly into business processes, so that an end business user (e.g., a Campaign Execution Manager) may understand, consume and interactively work with predictive results in the UI without direct help from an IT person or statistician. The results of the predictive functionality may be available during runtime and may be based on real-time data, according to one embodiment.

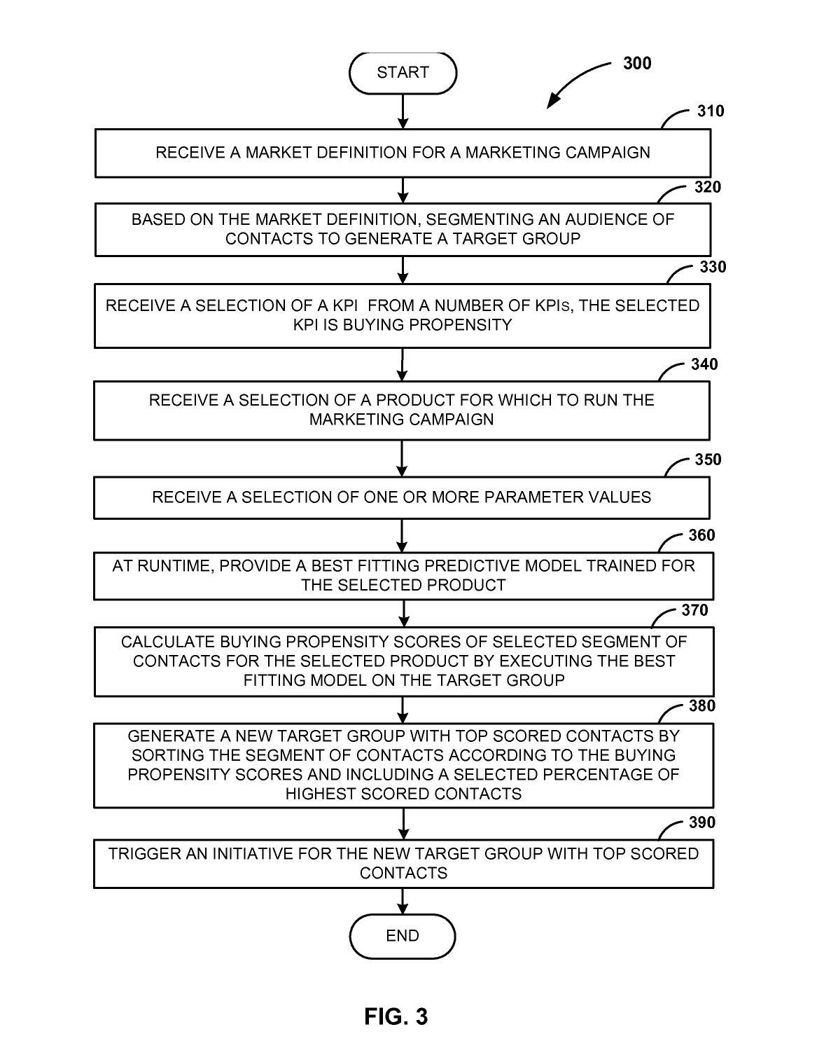

FIG. 3 illustrates process 300 for determining an optimized target group for a marketing campaign by calculating buying propensity, according to one embodiment. At 310, a market definition for a marketing campaign is received. In one embodiment, the marketing campaign is a business predictive process initiated by an end user. Defining market may include, for example, selecting industry, country, region, city, postal code, distribution channel, etc. At 320, an audience of contacts is segmented based on the market definition to generate a target group. For example, the customer data is filtered in response to executing selection statements based on specified criteria in the market definition. In one embodiment, an audience may include customers, contacts, visitors, interested parties, prospects, and any other parties. In one embodiment, the generated target group based on the segmented audience may be used as a training set for model training.

At 330, a KPI is selected from a number of KPIs, where the selected KPI is buying propensity (also called buying probability or product affinity). Based on the selected KPI buying propensity, available trained predictive models for a predictive scenario implementing the KPI are determined and provided in runtime of the marketing campaign. Since the predictive models are trained for one or more target objects, the target objects of those models are also provided in the runtime and displayed to the user. Thus, the trained predictive models with corresponding one or more target objects are provided in a GUI for the end user to select and consume. At 340, a selection of a product is received, where the product is the target object for which to run the marketing campaign. In one embodiment, the product is selected from the displayed in the GUI one or more target objects of the trained predictive models. In one embodiment, the Marketing Expert chooses a product to rank customers according to their buying propensity to the product. By choosing the product, the Marketing Expert selects also the predictive model trained for that product.

At 350, a selection of one or more parameter values is received, according to one embodiment. For example, a parameter value may be the number of clusters for a k-means algorithm. At 360, at runtime, a best fitting predictive model trained for the selected product is provided. At 370, buying propensity scores of selected segment of contacts is calculated for the selected product by executing the best fitting model on the target group. Once a predictive model is fitted, the scores for each customer can be calculated from the model fit. A score can be interpreted as estimated probability for example, that a customer buys a product. In one embodiment, a buying propensity score is calculated for and assign to each customer of the target group. Contacts are scored according to affinity to the product offering.

The end user may consume buying propensity predictive functionality to generate an optimized target group of customers for a marketing campaign for a product, according to one embodiment. At 380, a new target group with top scored contacts is generated by sorting the segment of contacts according to the buying propensity scores and including a selected percentage of highest scored contacts into the target group. Thus, the new target group is a target group optimized according to the buying propensity scores. In one embodiment, a percentage of top-ranked customers may be specified by the Marketing Expert. The specified percentage of customers is included in subsequent target group generation. In alternative embodiments, other parameter values may be specified such as volume sales for a product or budget, for example. When a percentage, of top-ranked customers, is specified, based on the percentage those customers are selected for the new target group having high affinity to the product. Thus the probability that contacts will respond to the marketing campaign is increased. At 390 an initiative for the new target group with the top scored contacts is triggered. For example, the Marketing Expert may start the marketing campaign with optimized target group, the group determined by calculating the buying propensity scores of the customers from the original target group. Thus, a Marketing Expert may execute effective marketing campaigns for a given product and market definition by using and consuming buying propensity functionality.

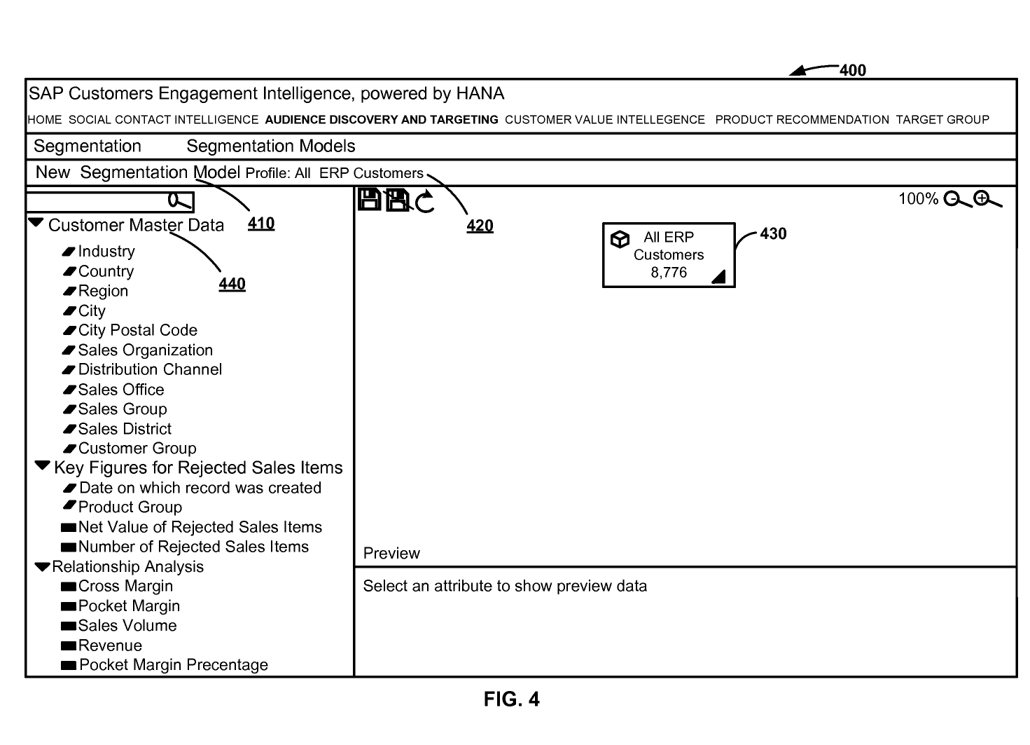

FIGS. 4-8 illustrate consumption of buying propensity functionality by an end user via one or more GUIs of a predictive functionality consumer application, according to one embodiment. Just as an example, the predictive functionality consumer application may be predictive customer segmentation and targeting tool such as SAP® Audience Discovery and Targeting (SAP® ADT).

FIG. 4 illustrates an initiation of buying propensity consumption process via GUI 400 of the predictive functionality consumer application, according to one embodiment. End users may consume predictive functionality via GUI 400. In one embodiment, the buying propensity consumption process may be initiated by creating a new segmentation model 410. For the creation of segmentation model 410, a segmentation profile such as segmentation profile 420 ‘All ERP Customers’ may be first selected. Initially, new segmentation model 410 includes segmentation node 430 that is a root segmentation node for segmentation profile 420 ‘All ERP Customers’. The root segmentation node of a segmentation profile may include the profile's complete audience to be segmented. Segmentation node 430, for example, may include all customers of an ERP system as determined by Customer Master Data 440. In one embodiment, Customer Master Data 440 is based on and includes entities from an in-memory predictive data model of source data. In one embodiment, a segmentation profile is associated with one or more predictive scenarios implementing one or more predictive functionalities. For example, a segmentation profile may be ‘CRM Business Partner Buying Propensity Profile’. Further, a segmentation profile is associated with a database view of the source data.

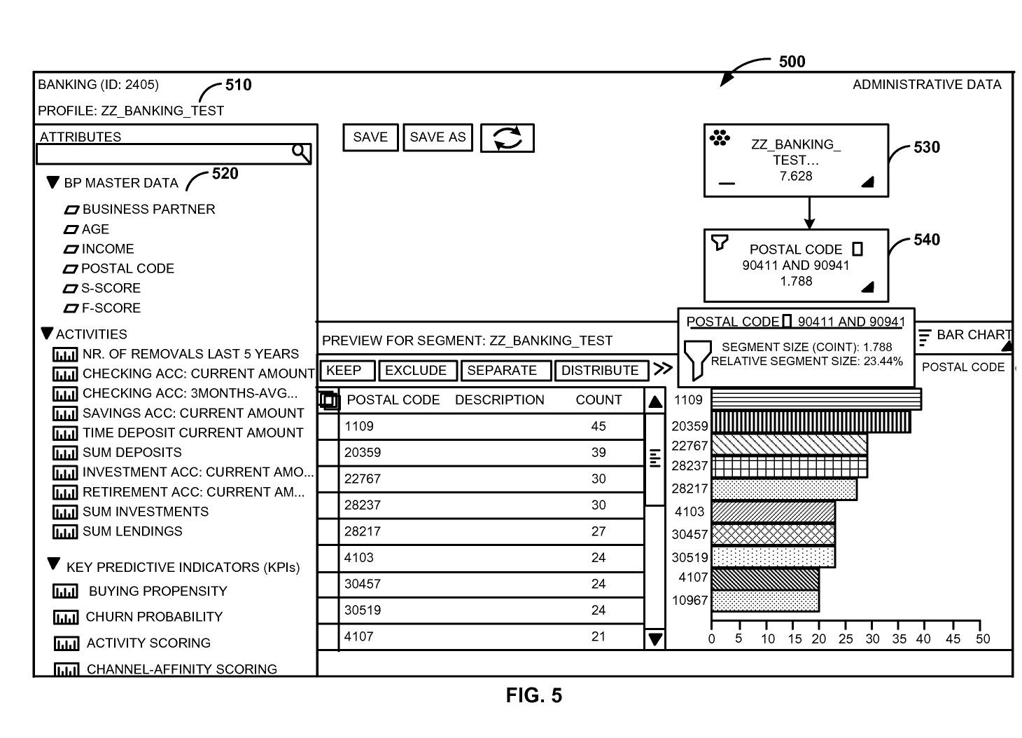

GUI 500 of FIG. 5 illustrates segmented audience according to entered selection criteria by an end user, according to one embodiment. Segmentation profile 510 ‘ZZ_BANKING_TEST’ is selected. In one embodiment, segmentation profile 510 ‘ZZ_BANKING_TEST’ includes an audience to be segmented, where the complete audience of segmentation profile 510 ‘ZZ_BANKING_TEST’ is represented by root segmentation node 530. Segmentation node 530, for example, may include all customers of a Customer Relationship Management (CRM) system as determined by Business Partner (BP) Master Data 520, e.g., 7,628 customers. Business Partner (BP) Master Data 520 may be based on and includes entities from an in-memory predictive data model of source data from a CRM system.

In one embodiment, the audience of customers is segmented based on a market definition specified by the end user, i.e., Marketing Expert. For example, the Marketing Expert has specified that market should include customers from region with postal codes ‘90411’ and ‘90941’. Thus, upon specifying selection criteria to define the market, the audience of customers of root segmentation node 530 is segmented to generate a target group of customers, represented by segmentation node 540. Customers with postal codes ‘90411’ and ‘90941’ are included in the target group of customers, where those customers from segmentation node 530 with postal code different from ‘90411’ and ‘90941’ are filtered out. The audience may be segmented to identify the best customers or the customers with the highest probability of buying a product.

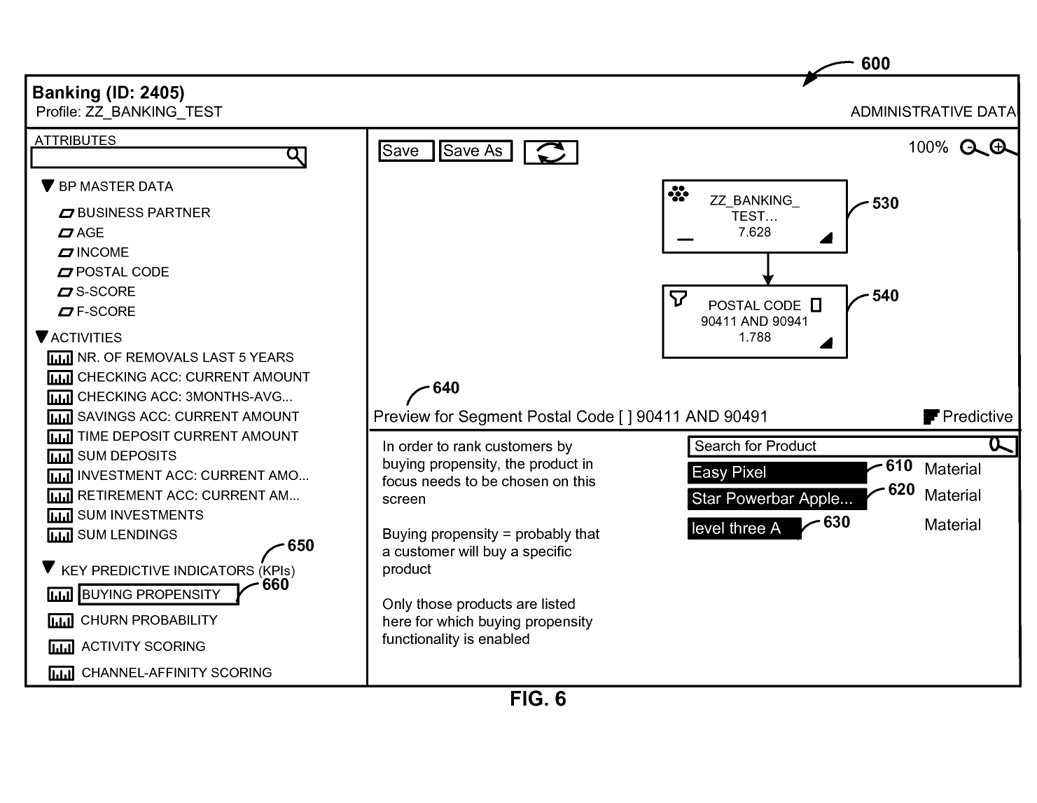

So far, the end user as represented by segmentation node 540 in GUI 500 has created a target group of customers with postal codes ‘90411’ and ‘90941’. Next, the end user may select a KPI from a number KPIs. FIG. 6 illustrates GUI 600 with selected KPI buying propensity 660 from KPIs 650. KPIs 650 may already be implemented by an advanced analyst or statistician. The end user has selected buying propensity 660 for consumption to score and determine customers with the highest probability of buying a product. As such, the business process initiated by the end user is a process for consuming predictive functionality buying propensity 660.

In one embodiment, upon selecting buying propensity 660 from KPIs 650, available trained predictive models are provided in runtime of the business process for consuming buying propensity 660. In one embodiment, the predictive models are trained to calculate buying propensity 660 for one or more target objects and a predefined target group. In the runtime of the business process, one or more target objects are provided in GUI 600 for which buying propensity predictive model is has been created and trained. Examples of such target objects are product 610 ‘Easy Pixel’, product 620 ‘Star Powerbar Apple’, and product 630 ‘level three A’, displayed in preview area 640 of GUI 600. In one embodiment, the end user may select a product listed in the preview area 640 for which to calculate buying propensity scores of customers of the created so far target group. In one embodiment, those products are displayed in preview area 640, for which predictive functionality buying propensity 660 is enabled.

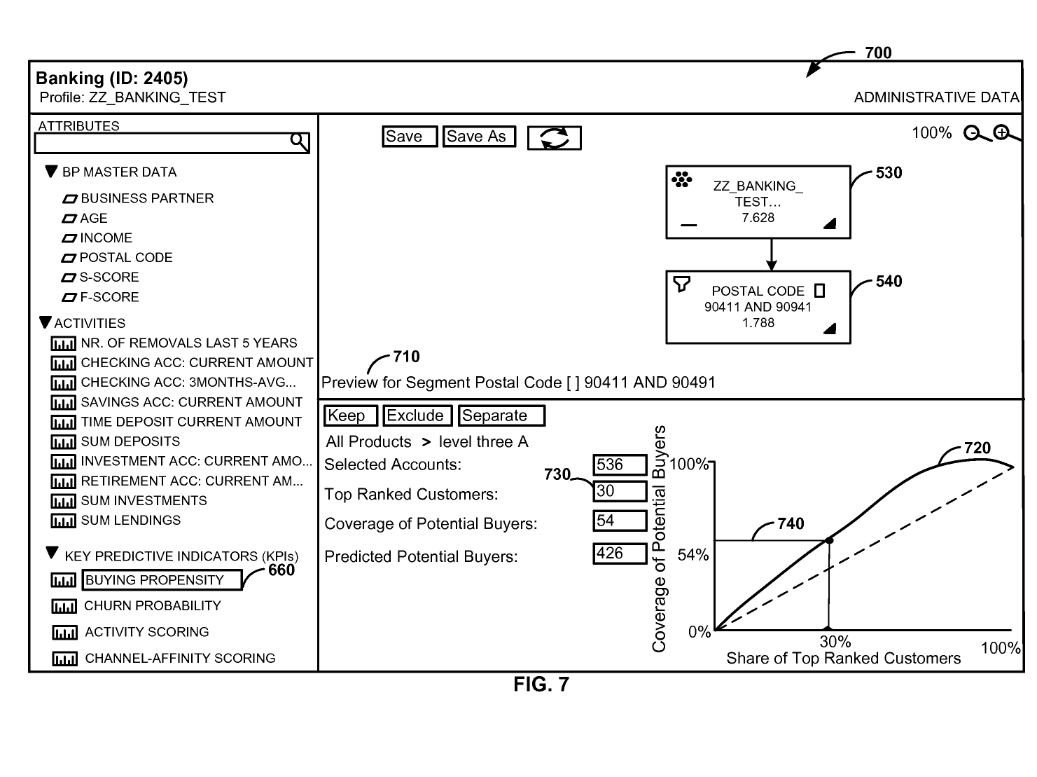

In one embodiment, the end user selects the target object for which to calculate buying propensity scores, e.g., product 630 ‘level three A’. FIG. 7 illustrates GUI 700 that shows in preview area 710 calculated scores of buying propensity 660 for product 630 ‘level three A’ and the target group of customers of segmentation node 540. Preview area 710 shows a Lorenz Curve 720. In one embodiment, a trained predictive model such as a best fitting model is applied to score all customers within segment node 540 by their buying propensity of product 630 ‘level three A’. Lorenz Curve 720 shows the cumulated percentage of top scored or ranked customers (e.g., x-axis) by the coverage of actual buyers in the training set (e.g., y-axis) as calculated by model training. In other words, Lorenz Curve 720 shows how much coverage of potential buyers can be gained per share of top ranked customers. Lorenz Curve 720 is calculated on current segmentation node 540 of customers.

Based on the displayed Lorenz Curve 720 in the GUI 700, the end user may optimize market coverage of potential buyers based on the calculated buying propensity scores. For example, the Marketing Expert might desire to contact 30% of the top-scoring contacts. In such case, the Marketing Expert may specify the desired percentage, for example, by entering the percentage value as illustrated in field 730. In one embodiment, an alternative for specifying the percentage is slider 740 of Lorenz Curve 720. By moving slider 740 on the x-axis back and forth, the end user may choose a percentage value of the share of top-ranked customers.

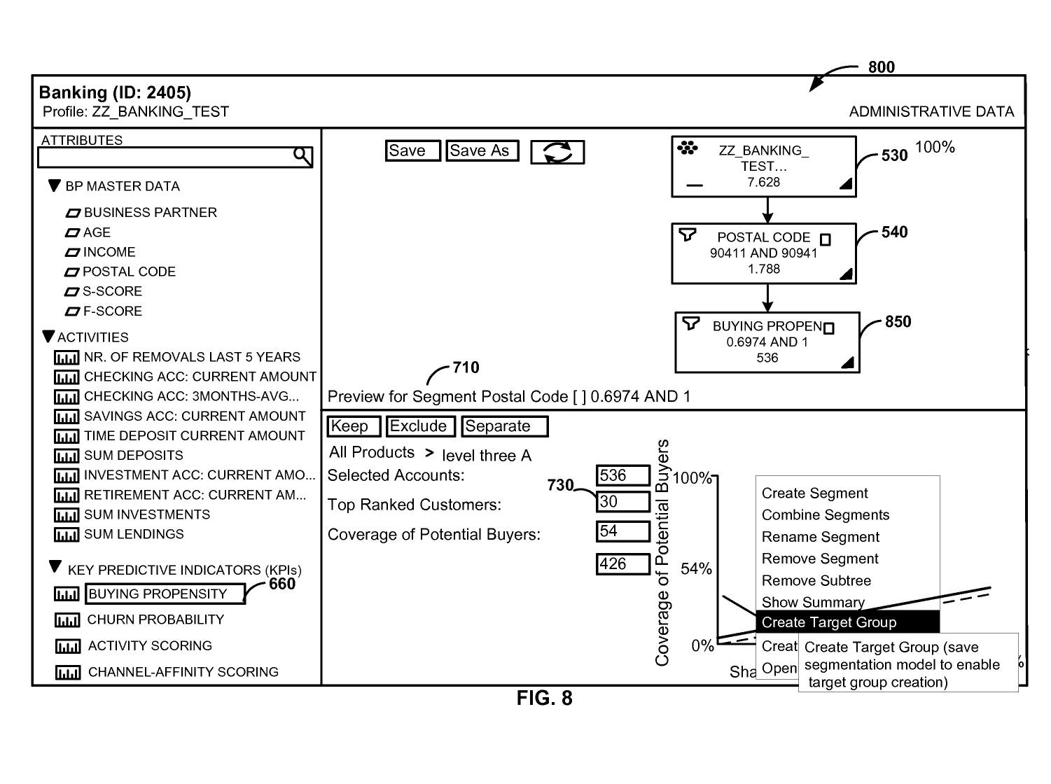

When a percentage for top-ranked customers is specified, based on the percentage a new segmentation node with those customers having high affinity to the product, according to the percentage, are selected for a new target group. FIG. 8 illustrates GUI 800 that shows a new segmentation node 850. In one embodiment, segmentation node 850 includes 30% of the top-ranked customers from segmentation node 540. In one embodiment, the new created segmentation node 850 may be used by the end user to create a new target group with the customers of segmentation node 850. The new target group is a target group optimized according to the buying propensity scores.

In one embodiment, steps performed by the end user to consume the predictive functionality do not require interruption of the initiated business process. Predictive functionality is consumed directly in the UI during the runtime of the business process. Business users may consume and interactively work with predictive results without help from an IT person. The predictive results are available in the runtime of the business process initiated by the business user and the need of transferring predictive results by statisticians back to the business users is overcome.

FIG. 9 illustrates a model training process 900 to calculate a model fit, according to one embodiment. Model training or fitting may be performed by a business analyst. At 910, a request to build a new predictive model is received. In one embodiment, model training 900 may be initiated in response to a request from a business user. Alternatively, model training can be initiated without an explicit request from a business user.

At 920, selection of a predictive scenario for a predictive model is received. In one embodiment, an already implemented by an advanced analyst predictive scenario is selected, where the predictive scenario specifies a combination of business context, data source, and assigned statistical method. An in-memory database table model representing the predictive scenario is stored and available in the runtime of the process initiated by the business analyst. At 930, selection of a target object for the predictive model is received. At 940, selection of a target variable for the predictive model is received. A target variable is the variable related to the target object, which is included in the statistical calculation. The target variable may represent a success of an outcome of a customer decision derived from historic data, for example, e.g., if a customer bought the product in focus, or not. Thus, the predictive model to be built specifies the selected predictive scenario including the selected target object and the target variable. The target variable and the target object are selected from an in-memory source data model, according to one embodiment. At 950, selection of a training set on which to train the predictive model is received. The training set may be a target group of contacts for which the predictive outcome is known from historic data. In one embodiment, a segmentation object representing the target group is stored and available in the runtime of the process of initiated by the business analyst. In one embodiment, once the predictive scenario, the target object, the target variable, and the training set are specified, the business analyst may set the predictive model to be in a status of “In Preparation”. Once the status has changed to “In Preparation” the specification of the predictive model (i.e. predictive scenario, target object, target variable, training set) cannot be changed anymore, according to one embodiment. While the predictive model is in preparation, the predictive model may be trained.

At 955, a selection of a statistical method for training the predictive model is received. In one embodiment, one or more statistical methods may be specified in configuration of the predictive scenario. Therefore, the business analyst selects the statistical method from those one or more specified methods, according to one embodiment. Examples include, but are not limited to, logistic regression, decision tree, or any other, which is part of the configured predictive scenario.

At 960, a selection of one or more predictors is received. A predictor is an explanatory (independent) variable in a predictive model. Examples of predictors include, but are not limited to, age, income, house hold size, living region, gender, past buying behavior, etc. Predictors may be historical information about a customer, which are used to predict an outcome, for example, buying of a product. In on embodiment, a selection of one or more model parameters may also be received. Model parameters may be required for specification of certain predictive models. For example, a model parameter may be the number of clusters for a k-means algorithm. In one embodiment, a selection of time constraints may also be received. For example, a start date and an end date may be selected. The start date may represent the start date for transactional data, which are included as predictors in the model fitting. The end date may represent the end date for transactional data, which are included as predictors in the model fitting.

At 970, the predictive model is trained on the selected training set for the selected predictor. Model training is performed by executing the statistical method with the selected one or more predictors and the selected training set. By training the predictive model, a model fit of the predictive model is calculated. In one embodiment, training the predictive model may include cross validation. Cross validation involves subdividing the training set into a number of subsamples by random. Each of the subsamples is used to validate the separate model fit, which is calculated on the remaining data. This is to investigate deviations in the fits for the subsamples for quality assessment. Finally, the overall model training is performed on the complete training set.

In one embodiment, the business analyst may choose to train the predictive model for another combination of one or more predictors to identify the best fitting predictive model. Thus, at 975, the business user may choose to calculate another model fit. In such case, steps 955, 960 and 970 may be repeated for various combinations of predictors.

At 985, the best model fit is determined. The business analyst may compare the calculated model fits and select the predictive model that is best fitting. At 990, the best model fit is deployed or published. The best model fit may be published to the runtime of the business user. Once published, the best model fit is available for consumption by the end user. For example, buying propensity for a certain product in ADT. In one embodiment, a context in which a predictive model is valid may be specified. In such case, at 995, an applicable scope is assigned to the best model fit. For example, calculation of buying propensity for a product may be applicable or valid for a certain region and may be inapplicable for another.

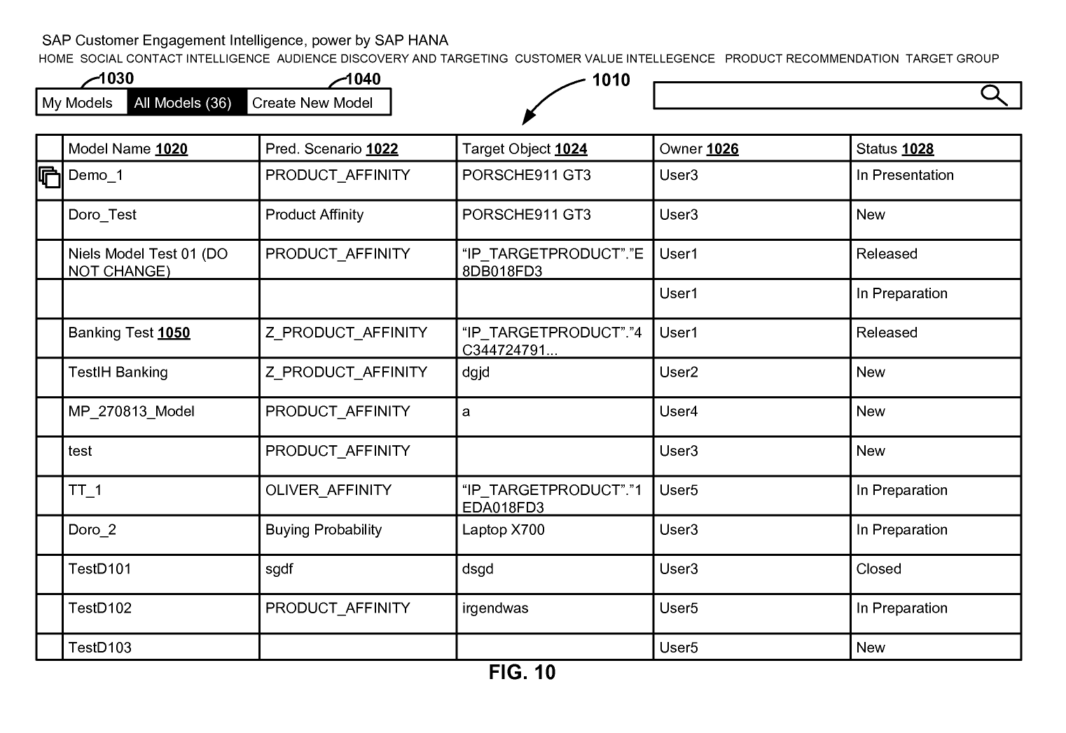

FIG. 10 illustrates table 1010 that includes a number of created predictive models, according to one embodiment. For each model, table 1010 may include a column that represents names 1020, predictive scenarios 1022, target objects 1024, owners 1026, and status 1028 of the model. Owner of the model may be the business analyst that has created the predictive model. In one embodiment, the business analyst may retrieve models of which he is an owner, e.g., by clicking button 1030. A new model can be created, e.g., by clicking button 1040. A model name from model names 1020 may be a hyperlink to navigate to details of the respective model. For example, the business analyst may navigate to details of predictive model 1050 ‘Banking Test’.

In one embodiment, exemplary statuses 1028 of predictive models may include, but are not limited to, ‘new’, ‘in preparation’, ‘released’, and ‘closed’. When a creation of a model is started, the model is in status ‘new’. Before the model is switched to status ‘in preparation’, a predictive scenario, a target object, a training set, and a target variable of the model may need to be specified. Once, switched to status ‘in preparation’ those characteristics may not be editable. While the predictive model is ‘in preparation’ applicable scope of the model may be defined as well as the model may be fitted to the selected training set (i.e., trained). Before the model may be switched to status ‘released’, a best fitting model may need to be specified. Once, the model fit is switched to status ‘released’, the model fit marked and selected as best is published to the runtime environment of a predictive functionality consumer application. When the status of the model is “released” the applicable scope as well as calculated model fits can still be changed and enhanced. Once, the model fit is switched to status ‘closed’, the predictive model is no longer active. Applicable scope, model fits, and target object of the model may not be editable anymore.

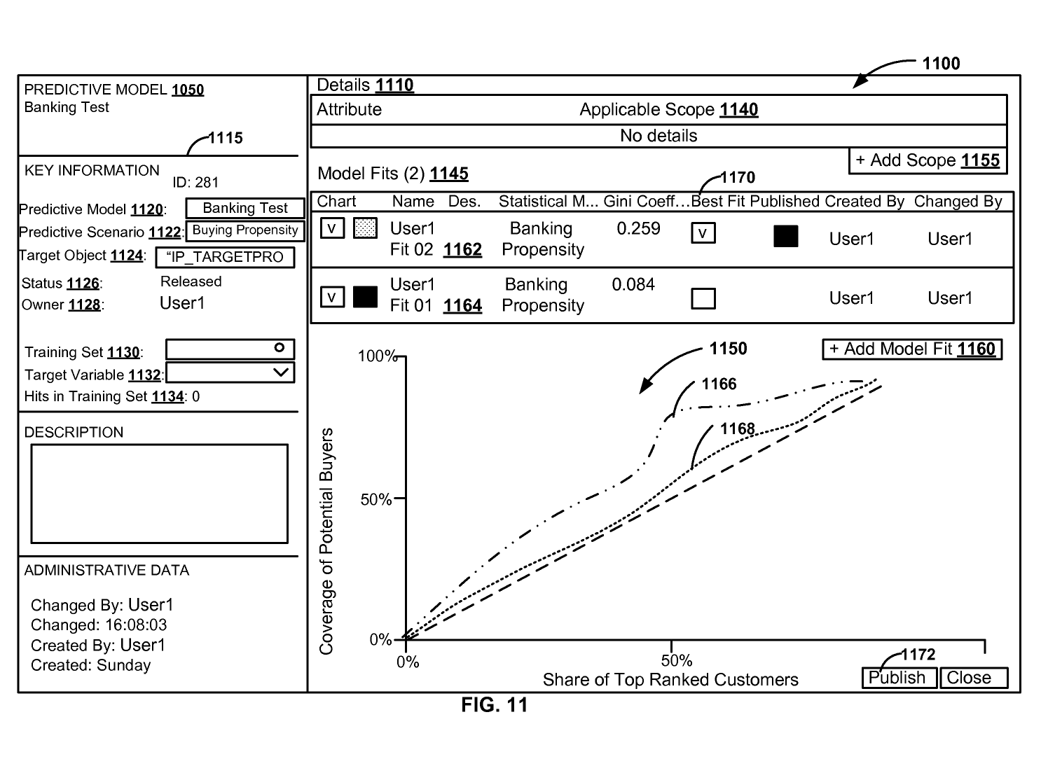

FIG. 11 illustrates a GUI 1100 showing details of a predictive model, according to one embodiment. The predictive model shown on GUI 1100 is model 1050 ‘Banking Test’. Side panel 1115 illustrates header information of predictive model ‘Banking Test’ 1050. Header information may include name of predictive model 1120, predictive scenario 1122, target object 1124, e′, status 1126, owner 1128, training set 1130, target variable 1132, hits in the training set 1134, etc. Details display area 1110 shows further details of predictive model ‘Banking Test’ 1050. Details may include Applicable Scope 1140 (no details illustrated), a table 1145 that includes one or more calculated model fits and chart 1150 that includes one or more Lorenz curves, related to model fits. A business analyst may assign various characteristic values as applicable scope for a predictive model 1050 ‘Banking Test’, for example, by pressing button 1155. The available characteristics need to be configured in the predictive scenario. Further, the business analyst may also add model fits to predictive model 1050 ‘Banking Test’, for example, by pressing button 1160. Table 1145 includes model fit 1162 ‘User1 Fit 02’ and model fit 1164 ‘User1 Fit 01’. Chart 1150 includes Lorenz curve 1166 corresponding to model fit 1162 ‘User1 Fit 02’ and Lorenz curve 1168 corresponding to model fit 1164 ‘User1 Fit 01’. Further, the business analyst may select the best model fit by checking one of boxes 1170, and publish selected best model fit of predictive model 1050 ‘Banking Test’ by pressing button 1172.

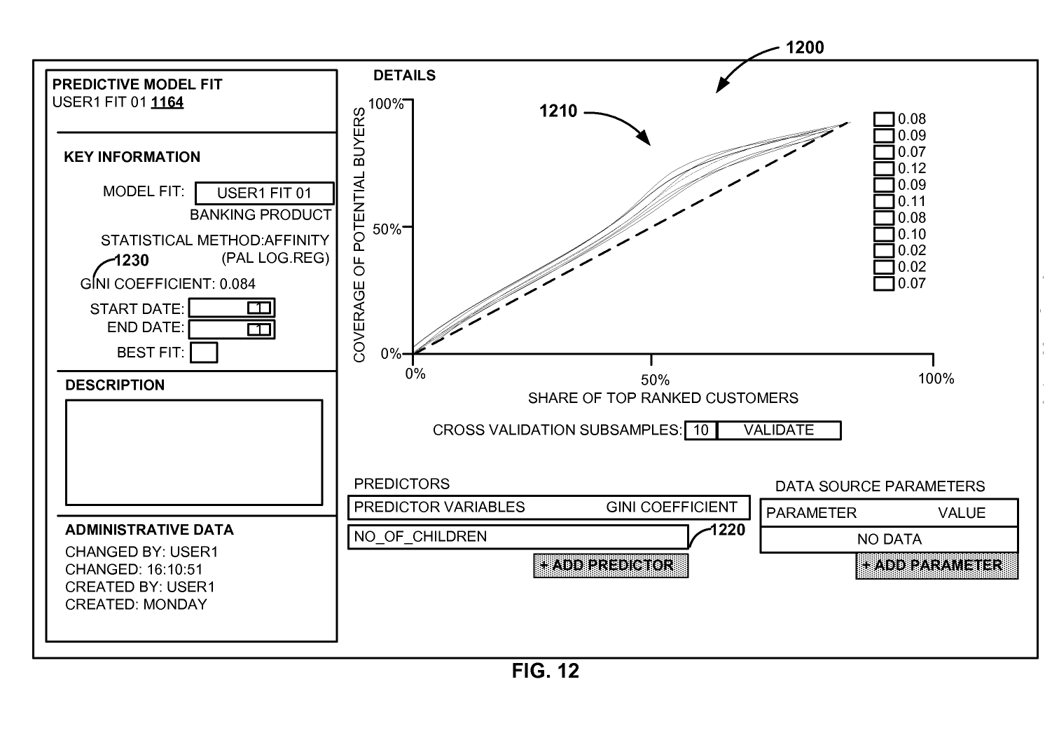

FIG. 12 illustrates a GUI 1200 showing details of a model fit, according to one embodiment. The model fit shown on GUI 1200 is model fit 1164 ‘User1 Fit 01’. Chart 1210 shows a number of model fits calculated for different subsamples. The final model fit 1164 ‘User1 Fit 01’ is calculated on the complete training set. For example, model fit 1164 ‘User1 Fit 01’ is validated on a cross validation of ten subsamples. Further, model fit 1164 ‘User1 Fit 01’ is trained using predictor 1220, e.g., ‘NO_OF_CHILDREN’. The predictive quality of model fit 1164 ‘User1 Fit 01’ is represented by Gini Coefficient 1230 and is estimated to be equal to 0.084. A Gini coefficient is a quality coefficient that indicates the goodness of the model fit in a range between 1 and −1. It is a calculated area between a Lorenz curve and a bisecting line.

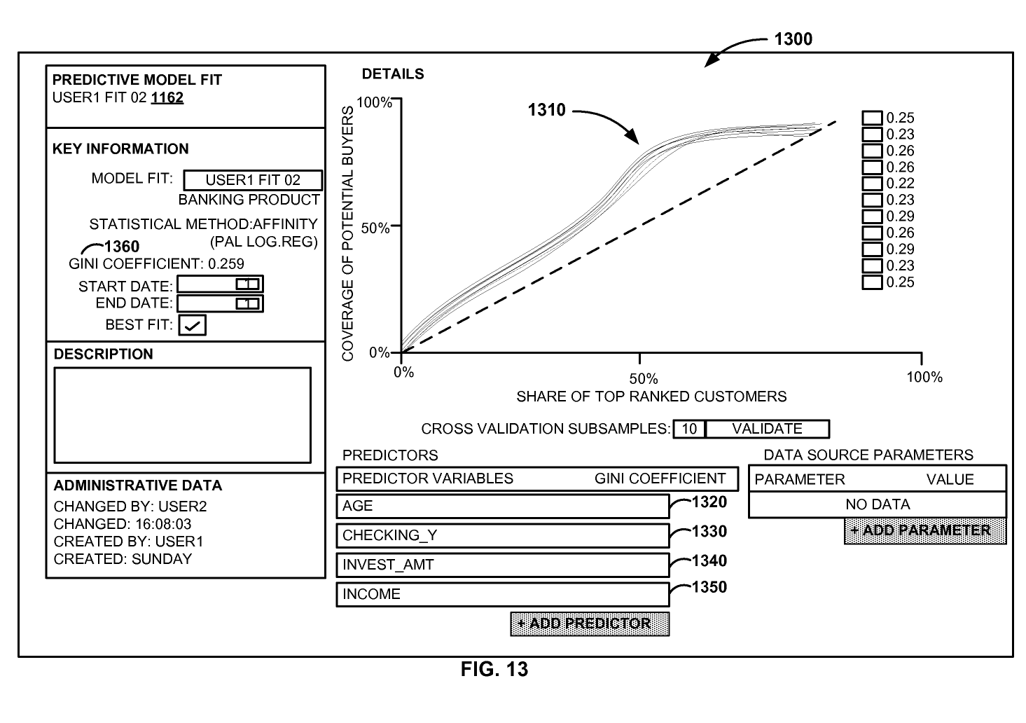

FIG. 13 illustrates a GUI 1300 showing details of a model fit, according to one embodiment. The model fit shown on GUI 1300 is model fit 1162 ‘User1 Fit 02’. Chart 1310 shows a number of model fits calculated for different subsamples. The final model fit 1162 ‘User1 Fit 02’ is calculated on the complete training set. Model fit 1162 ‘User1 Fit 02’ is also validated on a cross validation of ten subsamples. Further, model fit 1162 ‘User1 Fit 02’ is trained using predictor 1320, e.g., ‘AGE’; predictor 1330, e.g., ‘CHECKING_Y’; predictor 1340 ‘INVEST_AMT’, predictor 1350, e.g., ‘INCOME’. The predictive quality of model fit 1162 ‘User1 Fit 02’ is represented by Gini Coefficient 1360 and is estimated to be equal to 0.259. In one embodiment, model fit 1162 ‘User1 Fit 02’ and model fit 1164 ‘User1 Fit 01’ are based on the same predictive scenario. However, by using more predictors to train model fit 1162 ‘User1 Fit 02’ compared to model fit 1164 ‘User1 Fit 01’, the business analyst obtains better predictive quality.

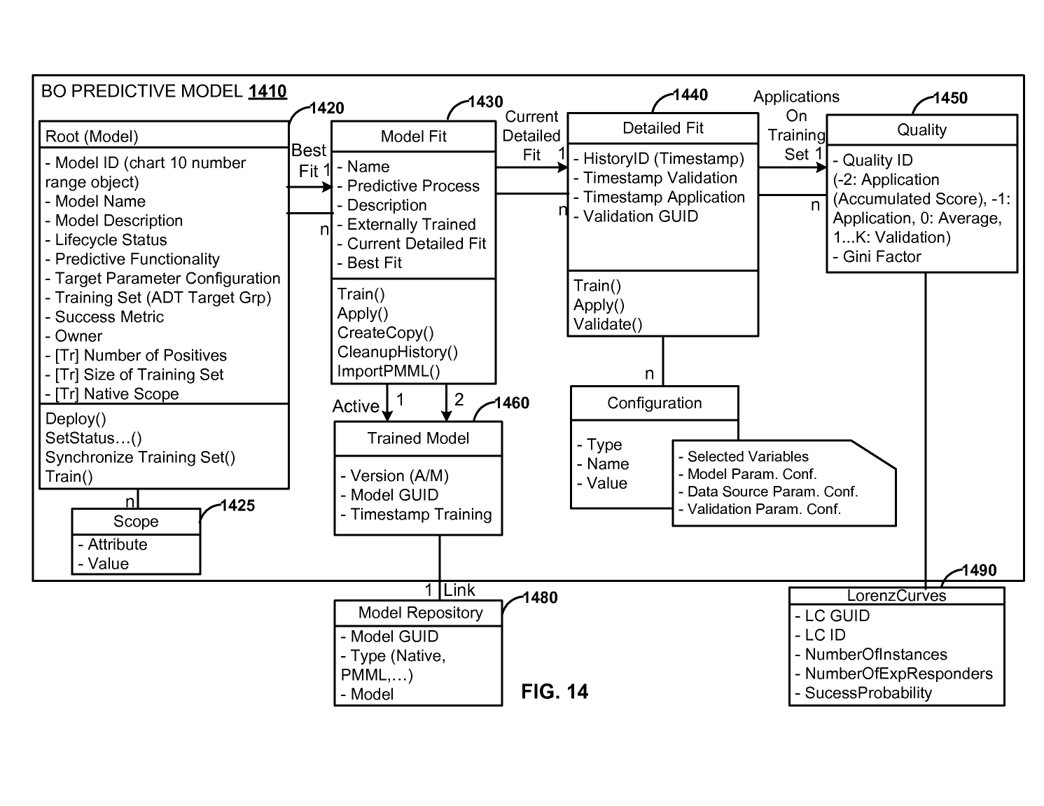

FIG. 14 illustrates representation of a predictive model, according to one embodiment. In one embodiment, a predictive model may be implemented as a business object. For example, Business Object (BO) 1410 ‘Predictive Model’ is a serialized representation of trained predictive models. Business Object (BO) 1410 ‘Predictive Model’ manages in the model repository instances of trained predictive models. BO of a predictive model includes a root of the model. For example, BO 1410 ‘Predictive Model’ includes root 1420. Attributes of root 1420 may include a model identifier, a model name, a model description, a lifecycle status, a predictive functionality (predictive KPI), a target parameter configuration, a training set, a success metric (target variable), an owner, number of positives, size of the training set, and a native scope. Actions that can be performed on root 1420 include, but are not limited to, deploy, set status, synchronize training set, train, etc. In one embodiment, business analyst may specify a new training set for a predictive model. In such case the synchronizing training set action allows automatic recalculation of training set while retaining the predictive model. A predictive model may also be assigned an applicable scope. In one embodiment, root 1420 is associated with one or more applicable scopes such as scope 1425.

Root 1420 may be associated with one or more model fits of the predictive model 1410 such as model fit 1430. Further, a single model fit from the one or more model fits may be selected as a best fit. Attributes of model fit 1430 include, but are not limited to, name, associated predictive process, description, an attribute specifying whether the model fit is calculated by internal or external training, a reference to a current detailed fit such as detailed fit 1440, and an attribute indicating whether the model fit is the best fit. Actions that can be performed on model fit 1430 include, but are not limited to, train, apply or execute, create copy, cleanup history, import, etc. Trained models or model fits can be imported via a Predictive Model Markup Language (PMML) interface, so that also externally trained models by another tool can also be stored and processed.

A model fit of a predictive model is associated with one or more detailed fits. For example, model fit 1430 may be associated with detailed fit 1440. A single detailed fit from the one or more detailed fits may be selected as a current detailed fit. Detailed fit 1440 of a predictive model further specifies a history identifier of a model fit, a timestamp of the validation of a model fit (e.g., a point in time when the model fit has been validated), a timestamp of the application of the model fit (e.g., a point in time when the model fit has been applied), a global universal identifier (GUID) of the validation of the model fit, etc. A detailed fit may also refer to a quality of a model fit. For example, detailed fit refers to quality 1450. Quality 1450 includes an attribute that represents a Gini factor of the model fit. Further, quality 1450 is associated with Lorenz Curve 1490. Each model fit 1430 is associated with trained model 1460. Trained model 1460 which is active is linked to and referenced by model repository 1480. Upon receiving a request to consume a predictive model represented by BO ‘Predictive Model’ 1410, respective instance of BO 1410 ‘Predictive Model’ to be consumed may be determined based on trained model 1460.

In one embodiment, unified actions on predictive models are provided based on BO 1410 ‘Predictive Model’. Such unified actions may include, but are not limited to, manage, train, fit, validate, schedule update, remote deploy of models, etc. The unified actions are agnostic or independent of implementation technology, statistical method and business process. Table 1 below represents an exemplary instance of a Business Object (BO) 1410 ‘Predictive Model’.

TABLE 1
Model

| Predictive KPI | PRODUCT_AFFINITY |
|---|---|
| Target Parameter Configuration | “TARGET_PRODUCT”: |
| | “1EDA018FD3CCD411858800902761A739” |
| Training Set | 5CF3FCDB4CDC1ED2B3EFC998B305C1B5 |
| Success Metric | 2 |

Applicable Scope

| Attribute | Value |
|---|---|
| ZZ_CRM_BUSINESS_PARTNER.CO | DE |
| UNTRY | |
| ZZ_CRM_BUSINESS_PARTNER.BU | 0001 |
| _GROUP | |

Fit

| | |
|---|---|
| Statistical Method | PRODUCT_AFFINITY_LOGR |

Detailed Fit

| | |
|---|---|
| Selected Variables | “PP01_NET_VALUE”, “PP02_NET_VALUE” |
| Model Parameter Configuration | |
| Datasource Parameter Configuration | “IP_DOC_DATE_START”: “2000-01-01”, |
| | “IP_DOC_DATE_END”: “2013-12-31”, |
| | “IP_REFPRODUCT01”: “E8DB018FD3CCD41 |
| | 1858800902761A739”, |
| | “IP_REFPRODUCT02”: “68DA018FD3CCD41 |
| | 1858800902761A739” |
| Validation Parameter Configuration | “K”: “3” |

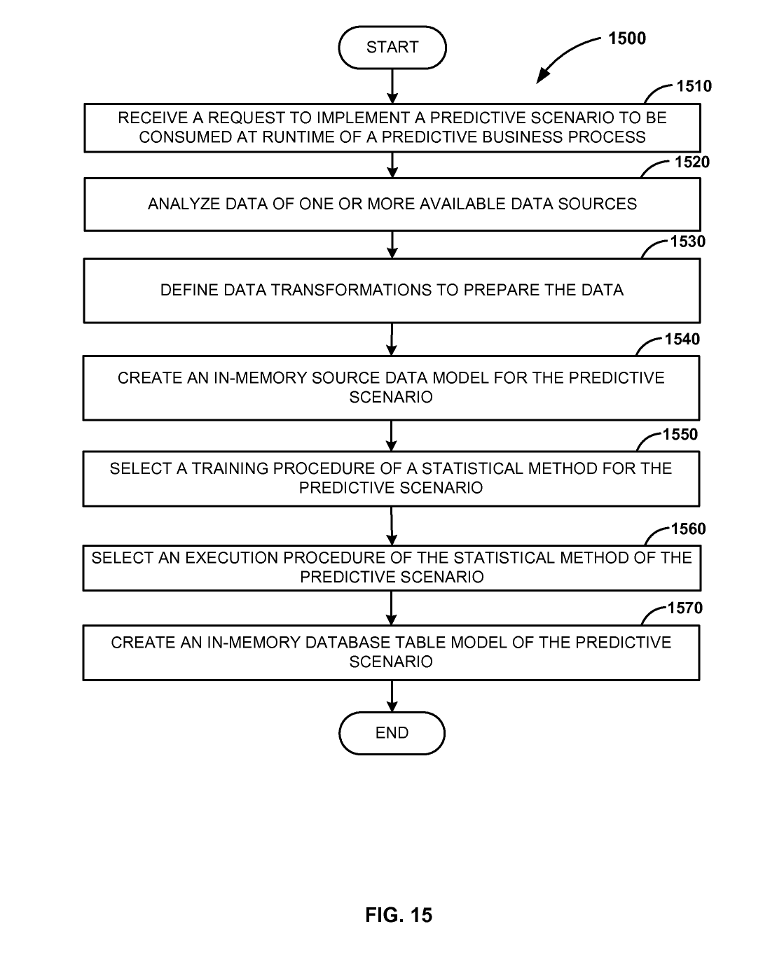

FIG. 15 illustrates process 1500 for implementing a predictive scenario, according to one embodiment. One predictive functionality may be implemented by different statistical and data mining algorithms. Therefore, one or more predictive scenarios that are implementations of a predictive functionality may be created. In one embodiment, a user with an advanced analyst role is implementing the predictive scenario. At 1510, a request to implement a predictive scenario is received. The predictive scenario to be consumed in runtime of a predictive business process, according to one embodiment. At 1520, data of one or more data source is analyzed by the advanced analyst, for example. By analyzing the data of the one or more data source, at 1530, data transformations are defined to prepare the data. Data transformations include, but are not limited to, data enrichment, cleansing, categorizations, aggregations, etc. In one embodiment, at 1540, an in-memory source data model for the predictive scenario may be created. The in-memory source data model is created based on the defined data transformation. In one embodiment, the in-memory source data model may be selected from pre-prepared in-memory source data models instead of being created. For example, the in-memory source data model may be selected from pre-prepared template database views such as HANA views. Exemplary views include, but are not limited to, attribute views, analytic views, and calculation views. An attribute view is an information view that may be used to define joins between tables and select a subset (or all) of their columns. The selected rows may be restricted by filters. Another application of attribute views may be in the role of a dimension in a star schema defined by an analytic view. In this case the attribute view adds more columns and also hierarchies as further analysis criteria to the analytic view. In the star schema of the analytic view the attribute view may be shown as a single dimension table that can be joined to a fact table. For example attribute views may be used to join employees to organizational units and then the result can be joined to a sales fact table in the analytic view. Analytic view is a set of physical tables interconnected in a star schema or fact tables surrounded by dimensions, calculations or restricted measures. Analytic views are typically defined on at least one fact table that contains transactional data. Using analytic views you can create a selection of measures—sometimes referred to as key figures—add attributes and join attribute views. In one embodiment, analytic views leverage the computing power of an in-memory database to calculate aggregate data, e.g., the number of cars sold per country, or the maximum power consumed per day. Analytic views may contain two types of attributes or columns—measures and key figures. Measures are attributes for which an aggregation may need to be defined. Calculation views are composite views used on top of analytical and attribute views. Calculation views may combine different fact tables. Calculation views may be defined as either graphical views or scripted views depending on how they are created. In one embodiment, graphical views can be modeled using the graphical modeling features of the SAP HANA Modeler. Scripted views are created as sequences of SQL statements. Exemplary HANA views may contain, for example, CRM Business Master Data, CRM transactional data (e.g., activities, leads, opportunities, sales, and service data, etc.), ERP SD transactional data (e.g., revenue, pocket margin, etc.), external customer satisfaction data, and other information. In one embodiment, the pre-prepared in-memory source data models once prepared can be enriched by the advanced analyst, for example.

At 1550, a training procedure of a statistical method for the predictive scenario is selected. The training procedure may be stored in an in-memory database library. The training procedure may be implemented in an SQL script, for example. The training procedure can be executed in-memory to allow for fast calculation in the main memory of a computer. At 1560, an execution procedure of the statistical method for the predictive scenario is selected. The execution procedure may be stored in an in-memory database library. The execution procedure may be implemented in an SQL script, for example. Another example may be an execution procedures stored in a connected R server or an algorithm provided by KXEN Inc. The execution procedure can be executed in-memory. At 1570, an in-memory database table model of the predictive scenario is created. Based on the in-memory database table model of the predictive scenario, predictive processing and calculations can be performed in the main memory. Both the training and execution procedure are natively written for in-memory calculation. Once prepared, the predictive scenario is available for consumption at runtime of a business predictive process, for example. The business analyst may define a predictive model based on the predictive scenario. The business analyst may select in a GUI the predictive scenario for basis of a predictive model to be created and trained.

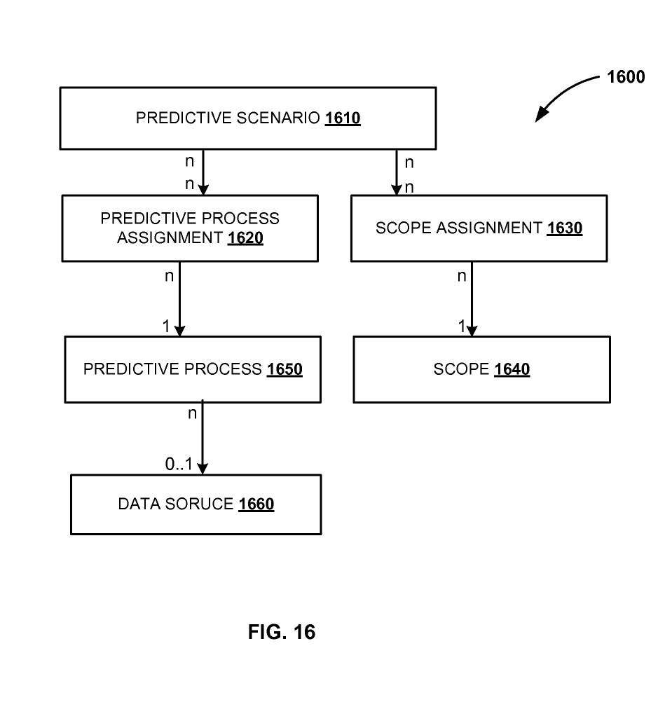

FIG. 16 illustrates an exemplary in-memory database view 1600 of a predictive functionality, according to one embodiment. Predictive scenario 1610 may be in-memory database view that connects to predictive process 1650 via predictive process assignment 1620. Predictive process assignment 1620 may be a database index that provides for lookup of predictive process 1610 assigned to predictive scenario 1610. Further, predictive scenario 1610 may be assigned scope 1640 via scope assignment 1630. Scope assignment 1630 may be a database index that provides for lookup of scope 1640 assigned to predictive scenario 1610. Predictive process 1650 is assigned to data source 1660 that provides data on which a key predictive indicator is calculated.

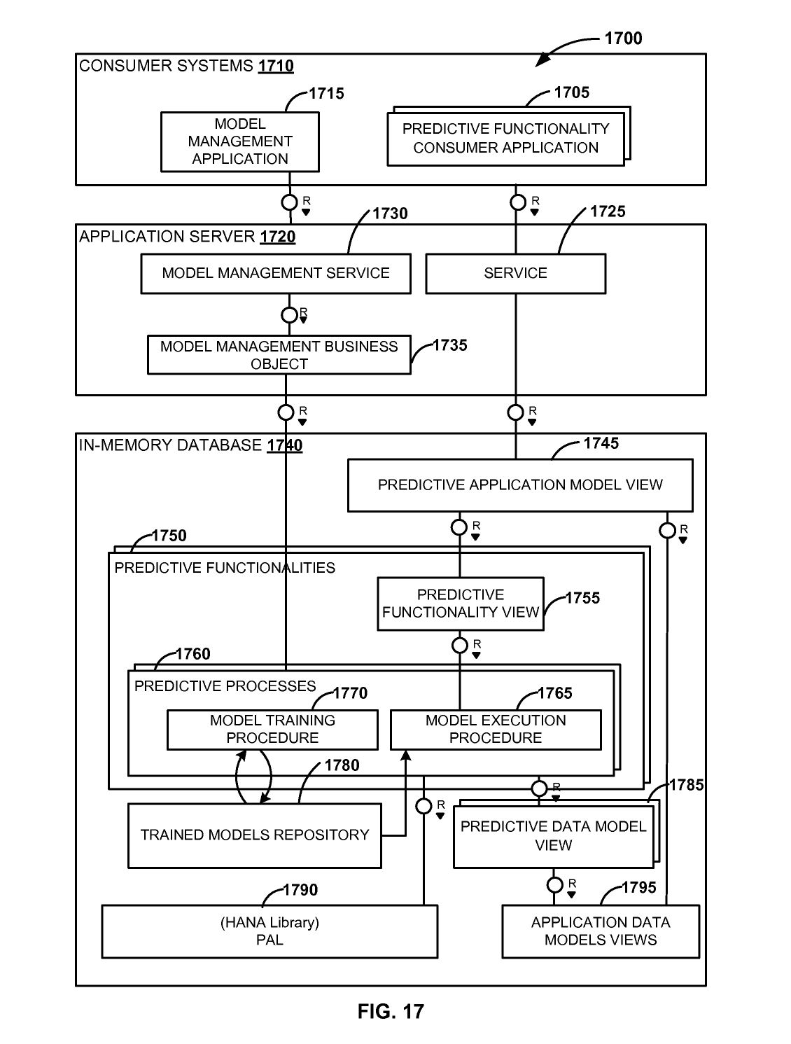

FIG. 17 illustrates exemplary computer system 1700 providing predictive functionality, according to one embodiment. One or more users, e.g., advanced analysts, business analysts, marketing experts, etc., operate on one or more consumer systems 1710. Users may request predictive services via predictive functionality consumer application 1705 or users may execute other operations related to management and processing of predictive models via model management application 1715.

One or more consumer systems 1710 access one or more predictive functionalities 1750, calculated in and provided by in-memory database 1740, via services provided by application server 1720. Consumer systems 1710 may be reporting clients or other client applications built on exemplary technologies including, but not limited to, HTML5, ABAP, business objects based technology such as SAP® BusinessObjects technologies, etc. In one embodiment, in-memory database 1740 is a database management system that employs a volatile storage. In-memory database 1740 may be based on column store architecture, e.g., SAP® HANA Database provided by SAP AG. In various embodiments, the in-memory database 1740 includes computing engine that may maximize the use of the operative memory provided by modern hardware. Relevant data is kept in the operative memory where read operations can run. Such in-memory computing engine may also be designed to make use of multi core CPUs by parallelization of execution. The in-memory computing engine can be a hybrid system that reduces the complexity of programming models and system landscapes by combining different paradigms in one system. The in-memory computing engine may comprise engines for column-based, row-based, and object-based in-memory or volatile storage as well as traditional nonvolatile storage. These engines may be integrated in a way that, for example, data from row based storage can be directly combined with data from column based storage.

Predictive functionality consumer application 1705 accesses, via service 1725, predictive application model view 1745. In turn, predictive application model view 1745 accesses one or more predictive functionalities 1750. Predictive application model 1745 controls input data received from consumer systems 1710 and result data provided by predictive functionality view 1755. Predictive functionality view 1755 provides real-time, predictive scores that are calculated in-memory. In one embodiment, predictive application model view 1745 and predictive functionality view 1755 may be in-memory database views such as HANA views. At runtime these views, e.g., predictive application model 1745 and predictive functionality 1755 make use of optimized in-memory calculation engines of in-memory database 1740 and thus enable for high performance of calculations.

One predictive functionality from predictive functionalities 1750 may be realized by different statistical and data mining algorithms, resulting in one or more predictive process implementations. For example, one or more predictive processes 1760 may be implemented for a predictive functionality from predictive functionalities 1750. Predictive functionality view 1755 controls which predictive process to use from predictive processes 1760, by checking an input parameter identifying the trained predictive model to be executed. At runtime, the input parameter identifying the trained predictive model is passed by predictive functionality consumer application 1705 to predictive functionality view 1755.

A predictive process from predictive processes 1760 includes model execution procedure 1765 and model training procedure 1770. Model execution procedure 1765 may be in-memory stored procedure applying an existing trained predictive model to data retrieved from predictive data model 1785 to calculate a prediction such as scores of a key predictive indicator. In one embodiment, model execution procedure 1765 and model training procedure 1770 may be implemented by SQL, L or other script. Trained predictive models are stored in and retrieved from trained models repository 1780. Model execution procedure 1765 calls function provided by Predictive Application Library (PAL) 1790. In one embodiment, SAP® HANA PAL is used. PAL 1790 defines functions that can be called from within SQL script procedures to perform analytic algorithms. PAL 1790 includes universal predictive analysis algorithms in various data-mining categories including, but not limited to, clustering, classification, association, time series, social network analyses, etc. Alternative libraries to PAL 1790 may be statistical libraries that are not natively implemented in HANA such as International and Statistic Library and R. In one embodiment, an advanced analysts creates predictive data model view 1785 based on customer data or application data model views 1795 such as CRM Business Master Data, CRM transactional data, ERP SD transactional data, etc.

In one embodiment, consuming one or more predictive functionalities 1750 by predictive functionality consumer application 1705 may be real-time. Execution of other operations related to management and processing of predictive models via model management application 1715 may also be real-time. Model management application 1715 accesses, via service 1730 and based on model management business object 1735, one or more predictive processes 1760. Example of model management business object may be BO predictive model 1410 (FIG. 14). In one embodiment, a business analyst selects a predictive process from predictive processes 1760 via model management application 1715 to trigger creation and training of a predictive model. Predictive models are trained by model training procedure 1770 and, once trained, predictive models are stored in trained models repository 1780 for consumption.

In one embodiment, an end user may initiate a business predictive process and request to consume a predictive KPI via predictive functionality consumer application 1705. The end user may define a market to generate a target group. At runtime, upon defining the market a segmentation object that represents the target group is generated. The segmentation object may be linked to a segmentation profile selected by the end user, at runtime. The segmentation object is passed to predictive functionality view 1755. Predictive functionality view 1755 determines a business object instance of a trained predictive model based on correspondence between the segmentation object and applicable scope associated with the trained predictive model as well as based on a

[symbol]

Some of the elements of the computer system architecture 1700 resemble the structure and functionality of software modules developed by SAP AG. However, other structures with similar functionalities could be found in software products developed by other vendors, as well. Alternative embodiments may utilize other kinds of computer system architectures.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

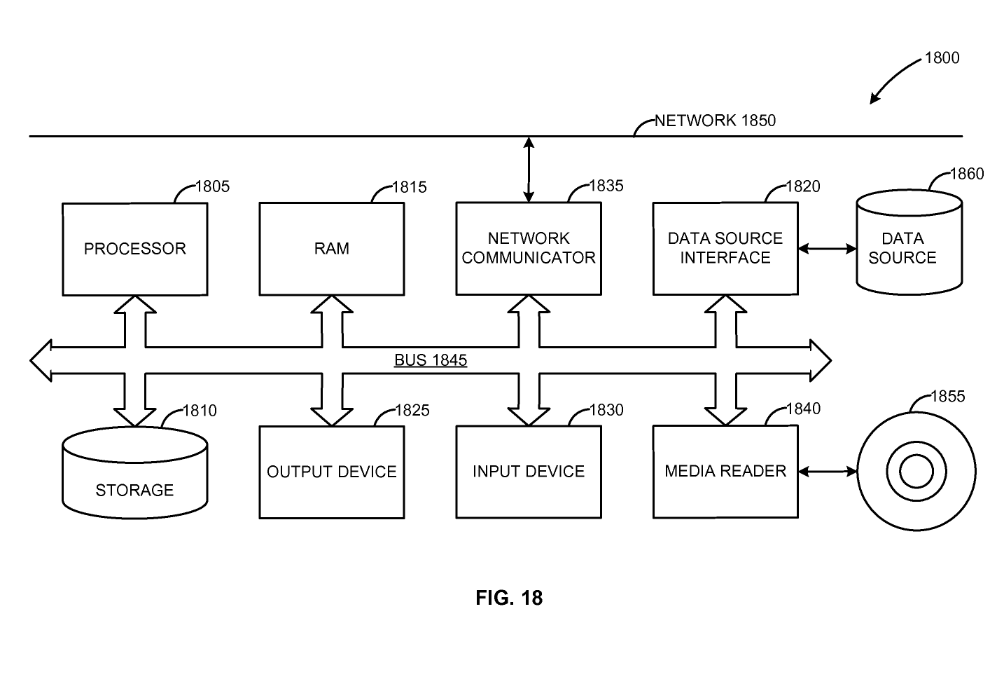

FIG. 18 is a block diagram of an exemplary computer system 1800. The computer system 1800 includes a processor 1805 that executes software instructions or code stored on a computer readable storage medium 1855 to perform the above-illustrated methods. The processor 1805 can include a plurality of cores. The computer system 1800 includes a media reader 1840 to read the instructions from the computer readable storage medium 1855 and store the instructions in storage 1810 or in random access memory (RAM) 1815. The storage 1810 provides a large space for keeping static data where at least some instructions could be stored for later execution. According to some embodiments, such as some in-memory computing system embodiments, the RAM X15 can have sufficient storage capacity to store much of the data required for processing in the RAM 1815 instead of in the storage 1810. In some embodiments, all of the data required for processing may be stored in the RAM 1815. The stored instructions may be further compiled to generate other representations of the instructions and dynamically stored in the RAM 1815. The processor 1805 reads instructions from the RAM 1815 and performs actions as instructed. According to one embodiment, the computer system 1800 further includes an output device 1825 (e.g., a display) to provide at least some of the results of the execution as output including, but not limited to, visual information to users and an input device 1830 to provide a user or another device with means for entering data and/or otherwise interact with the computer system 1800. Each of these output devices 1825 and input devices 1830 could be joined by one or more additional peripherals to further expand the capabilities of the computer system 1800. A network communicator 1835 may be provided to connect the computer system 1800 to a network 1850 and in turn to other devices connected to the network 1850 including other clients, servers, data stores, and interfaces, for instance. The modules of the computer system 1800 are interconnected via a bus 1845. Computer system 1800 includes a data source interface 1820 to access data source 1860. The data source 1860 can be accessed via one or more abstraction layers implemented in hardware or software. For example, the data source 1860 may be accessed by network 1850. In some embodiments the data source 1860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented in-memory end-to-end method for predictive analytics, the method comprising:
initiating a predictive business process to consume a predictive functionality;
at runtime of the predictive business process, retrieving from an in-memory database a trained predictive model, the trained predictive model based on a predictive scenario implementing the predictive functionality, the predictive scenario stored in the in-memory database; and
calculating a key predictive indicator by executing the trained predictive model, the calculating is performed in the in-memory database.

2. The computer method of claim 1 further comprising:
at the runtime of the predictive process, providing in a graphical user interface the calculated key predictive indicator.

3. The computer method of claim 1 further comprising:
creating the predictive scenario by a user with an advanced analyst role.

4. The computer method of claim 1 further comprising:
creating an in-memory source data model for the predictive scenario;
selecting a training procedure of a statistical method for the predictive scenario, the training procedure stored in the in-memory database;
selecting an execution procedure of the statistical method for the predictive scenario, the execution procedure stored in the in-memory database; and
creating an in-memory database view of the predictive scenario, the predictive scenario implementing the predictive functionality.

5. The computer method of claim 1 further comprising:
creating the trained predictive model by a user with a business analyst role, wherein the predictive scenario is available for selection at the runtime of the user with the business analyst role, and
training the predictive model by the user with the business analyst role.

6. The computer method of claim 1 further comprising:
receiving a request to train a predictive model for the predictive functionality;
receiving a selection of the predictive scenario;
receiving a selection of a target object;
receiving a selection of a target variable;
based on the predictive scenario, the target object, and the target variable, creating the predictive model;
receiving a selection of a training set on which to train the predictive model;
receiving a selection of a statistical method from specified, in the predictive scenario, one or more statistical methods;
receiving a selection of a first set of predictors; and
training the predictive model on the selected training set for the selected predictors by the selected statistical method to calculate a first model fit.

7. The computer method of claim 6 further comprising:
receiving a selection of a second set of predictors;
training the predictive model on the selected training set for the selected second set of predictors by the selected statistical method to calculate a second model fit;
based on a quality coefficient of the first model fit and a quality coefficient of the second model fit, specifying one from the first model fit and the second model fit to be a best model fit; and
deploying the best model fit for consumption.

8. The computer method of claim 6 further comprising:
assigning an applicable scope to the trained predictive model, wherein the applicable scope represents a valid business context for the trained predictive model.

9. The computer method of claim 6 further comprising:
upon receiving a request to consume the predictive functionality, determining an instance of the trained predictive model to retrieve, the instance determined automatically based on correspondence between the training set of the trained predictive model and a selected target group, and between the applicable scope of the trained predictive model and a selected business context.

10. A computer implemented method, the method comprising:
initiating a predictive business process to consume a predictive functionality;
receiving a definition of a business context for the predictive functionality;
upon receiving the definition of the business context, segmenting an audience to generate a target group;
receiving a selection of a key predictive indicator (KPI) from a plurality of key predictive indicators (KPIs) for the predictive functionality;
receiving a selection of a target object for which to apply the predictive functionality;
at runtime of the initiated predictive business process, retrieving a trained predictive model that is automatically determined;
a processor calculating scores of the selected KPI by executing the trained predictive model on the target group for the selected target object; and
in the runtime of the predictive process, displaying in a graphical user interface the calculated scores.

11. The method of claim 10, further comprising:
receiving the selection of the business context that is a market definition for a marketing campaign;
segmenting the source data set of contacts to generate the target group from the contacts;
receiving the selection of the KPI that is buying propensity;
receiving the selection of the target object that is a product for which the buying propensity is to be calculated for the target group;
at the runtime of the initiated predictive business process, retrieving a best fitting predictive model for the buying propensity; and
calculating a score of the buying propensity for each group member of the target group by executing the best fitting predictive model for buying propensity on the target group.

12. The method of claim 11, further comprising:
in the runtime of the predictive business process, displaying in the graphical user interface a Lorenz curve that illustrates the calculated score of the buying propensity for each group member of the target group and a market coverage of potential buyers;
receiving a selection of a parameter value that is a percentage of top-ranked customers; and
according to the percentage, creating a new segmentation of the contacts to generate an optimized target group for the marketing campaign.

13. The method of claim 10, wherein upon receiving the definition of the business context, segmenting the audience further comprises:
creating a segmentation object according to the definition of the business context, wherein the segmentation object linked to the predictive functionality in the runtime of the predictive business process.

14. The method of claim 10, further comprising:
upon receiving the selection of the KPI, displaying in a graphical user interface one or more target objects for which the predictive functionality is enabled, the target object selected from the displayed one or more target objects.

15. The method of claim 13, wherein upon receiving the definition of the business context, segmenting the audience further comprises:
associating with the segmentation object, a segmentation profile of an end user role which initiates the predictive business process, wherein the segmentation profile associated with the predictive functionality.

16. A computer system to process end-to-end method for predictive analytics, the system comprising:
a memory to store computer executable instructions;
at least one computer processor coupled to the memory to execute the instructions, the instructions comprising:
an in-memory database storing:
a predictive scenario implementing a predictive functionality, the predictive scenario represented by an in-memory database view;
a trained predictive model for the predictive scenario, the predictive model represented by a business object;
the in-memory database to:
process a request to consume the implemented predictive scenario, the request received upon initiation of a predictive business process;
provide, at runtime of the initiated predictive business process, the trained predictive model which is automatically determined; and
calculate a key predictive indicator by executing the trained predictive model in the in-memory database.

17. The computer system of claim 16, wherein the in-memory database further to:
at the runtime of the predictive process, provide in a graphical user interface the calculated key predictive indicator.

18. The computer system of claim 16, wherein the predictive scenario created based on a selected in-memory source data model for the predictive scenario, a selected training procedure of a statistical method for the predictive scenario, and a selected execution procedure of the statistical method for the predictive scenario, the execution procedure and the training procedure stored in the in-memory database.

19. The computer system of claim 16, wherein the predictive model created based on a selected predictive scenario, a selected target object, and a selected target variable.

20. The computer system of claim 16, wherein the predictive model trained on a selected training set and a selected at least one predictor.
